(19) United States
(12) Patent Application Publication
(10) Pub. No.: US 2013/0275430 A1
(43) Pub. Date: Oct. 17, 2013

(54) System and Method for Visually Representing Data

(71) Applicant: Jerald Hammann, Eden Prairie, MN (US)

(72) Inventor: Jerald Hammann, Eden Prairie, MN (US)

(21) Appl. No.: 13/645,868

(22) Filed: Oct. 5, 2012

Related U.S. Application Data
(60) Provisional application No. 61/544,083, filed on Oct. 6, 2011.

(51) Int. Cl. G06F 17/30

(52) U.S. Cl. CPC G06F 17/30598
USPC 707/737

(57) ABSTRACT

A computer-based system and method evaluates at least one data set, generates grouping based on the data set, and visually represents these groupings as a basis by which individual elements of the data set are evaluated.

### THE FIELD OF THE INVENTION

The present invention generally relates to the visual display of data for knowledge capture, for knowledge sharing and for decision-making

### BACKGROUND OF THE INVENTION

Measurement tools like thermometers and other weather-related, pressure-related, level-related and environment-related devices have existed for a long time. For example, a standard automotive dashboard is comprised of multiple gauges whose purpose is to inform the driver about the operation of the vehicle. Often these gauges are equipped with warning stimuli, such as a red background or a red light, when the gauge reading requires the driver's attention regarding some aspect of the operation of the vehicle.

In other environments, the scale upon which events are evaluated is inconstant. If, for example, annual sales in Year 1 was $200,000,000, and the preparer wanted to represent minimal but steady sales growth over the succeeding four years, representing $0 as the start-point of an x-axis or y-axis graph was sometimes undesirable because the sales growth would not be obvious to the observer. Graphical tools therefore developed to permit variation in the representation of data.

Other types of scales developed as well, like logarithmic and probability that might not have zero as an optimal starting axis. The graphical representation packages of today—as found in spreadsheet, database and standalone products—effectively address many of the expanding needs for representing data. However, other needs are poorly addressed or not addressed at all.

For example, representing percentile data, wherein the comparative values are determined from the data itself, is not effectively addressed through current graphical representation methods. As another example, representing multiple and diverse data points can often lead to either a cluttered representation, or in the alternate, to multiple charts each presenting limited data.

There is a desire to reduce the time necessary for a viewer to comprehend data. There is further an oft-conflicting desire to increase the usefulness of information contained in graphical representations. Often dense data is ignored or minimized because the effort required to comprehend the data is too large or requires information missing from the already-dense data. In other words, current methods of data representation often result in dense data that appears cluttered, and results in reduced comprehension, while still often excluding critical relevant associated data.

### SUMMARY OF THE INVENTION

One aspect of the present invention provides a computer-based method for visually representing data, comprising distributing at least one set of data across at least two groupings, visually representing the at least two groupings as a metric against which individual data elements are compared, and visually representing at least one individual data point in relation to the at least two groupings. This aspect of the present invention is further refined by associating data labels with the visually-represented groupings, associating attention criteria with the visually-represented groupings, associating data labels with the visually-represented individual data elements, and/or associating visually-distinct data labels with the individual data elements.

One aspect of the present invention provides a computer-based system for visually representing data, comprising means for distributing a population of data across at least two groupings, means for visually representing the at least two groupings as a metric against which individual data elements are compared, and means for visually representing at least one individual data point in relation to the at least two groupings. This aspect of the present invention is further refined by associating data labels with the visually-represented groupings, associating attention criteria with the visually-represented groupings, associating data labels with the visually-represented individual data elements, and/or associating visually-distinct data labels with the individual data elements.

### BRIEF DESCRIPTION OF THE DRAWINGS

FIG. 1 is, by way of example, a graphical representation of percentile data for a data set, along with the user's data represented relative to the percentile data.

FIG. 2 is, by way of example, a graphical representation of percentile data for a data set, along with the user's data represented relative to the percentile data. Addition data is also represented, including competitor data, competitor “basket” data, and regional data (e.g., state data).

FIG. 3 is, by way of example, a graphical representation of percentile data for a data set, along with the user's data represented relative to the percentile data. Addition data is also represented, including prior period data (e.g., four prior quarters).

FIG. 4 is, by way of example, visual basic programming code enabling the population of the graphical representations depicted in FIGS. 1-3.

FIG. 5 is, by way of example, visual basic programming code operating as a sub-routine to the code represented at FIG. 4, enabling the population of the values “below the bar” shown in the graphical representations depicted in FIGS. 1-3. FIG. 6 is, by way of example, visual basic programming code operating as a sub-routine to the code represented at FIG. 4, enabling the population of the values “above the bar” shown in the graphical representations depicted in FIGS. 1-3.

FIG. 7 is, by way of example, visual basic programming code operating as a sub-routine to the code represented at FIG. 4, enabling the movement of the measurement lines “within the bar” shown in the graphical representations depicted in FIGS. 1-3.

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

### I. Graphical Representations

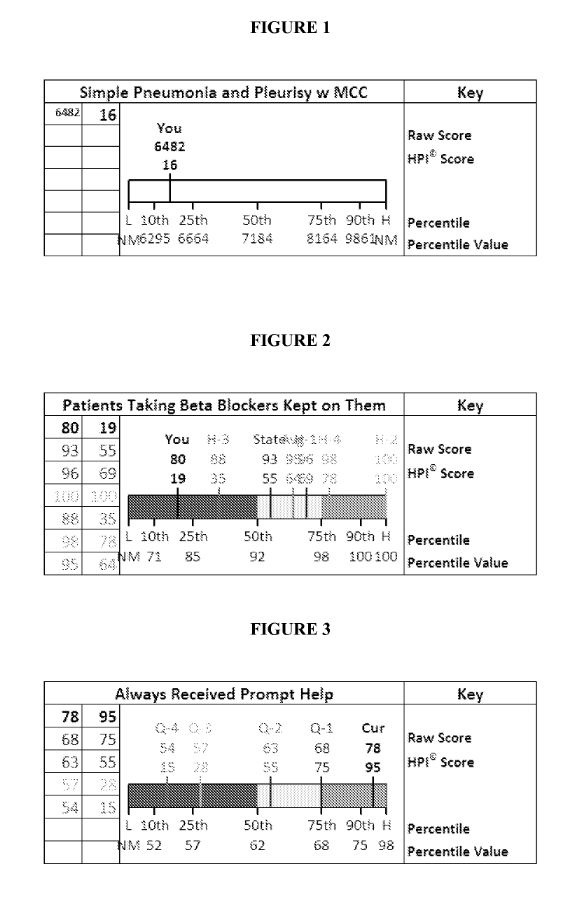

FIGS. 1-3 show, by way of example, three different graphical representations of the invention: a single variable example (FIG. 1), and two multi-variable examples, the first including comparative competitive data (FIG. 2) and the second including comparative time-series data (FIG. 3).

In each representation, “below the bar” data includes labels for “L”, “10th”, “25th”, “50th”, “75th”, “90th” and “H”, representing Low, 10th Percentile, 25th Percentile, 50th Percentile, 75th Percentile, 90th Percentile and High values. These values are labeled “Percentile” in the Key. “Below the bar” data further includes numeric values associated with each data label, or a “NM” value, representing data values that might be outlier values. These values are labeled “Percentile Value” in the Key.

In each representation, “above the bar” data includes labels to associate data with an entity or measure. Labels like “You”, “H−1”, “State”, “Avg” and “Q−1” represent the primary entity, its first competitor, the state average in which it operates, the average of a basket of competitors, and the prior quarter results for the primary entity. “Above the bar” data further includes the “raw” values associated with the labels. These values are labeled “Raw Score” in the Key. “Above the bar” data further includes the percentilized values associated with the raw values. These values are labeled “HPI Score” in the Key.

In each representation, “within the bar” lines are calibrated to visually-represent the position of the percentilized values on the spectrum from the Low value in the data set to the High value in the data set, distributed based on percentile values. For example in FIG. 1, the “within the bar” line is located 16% of the way along the bar from left to right, corresponding to the percentilized value of 16 associated with the raw value of 6,482.

While the described embodiment depicts percentilization as the method of distributing data, other methods of distribution will be evident to one skilled in the art and might be used without departing from the spirit of the invention. As will further be realized, the graphical representation is capable of other and different embodiments and its several details are capable of modification in various obvious respects, all without departing from the scope of the present invention. Accordingly, the graphical representations are to be regarded as illustrative in nature and not as restrictive.

### II. Programming Logic

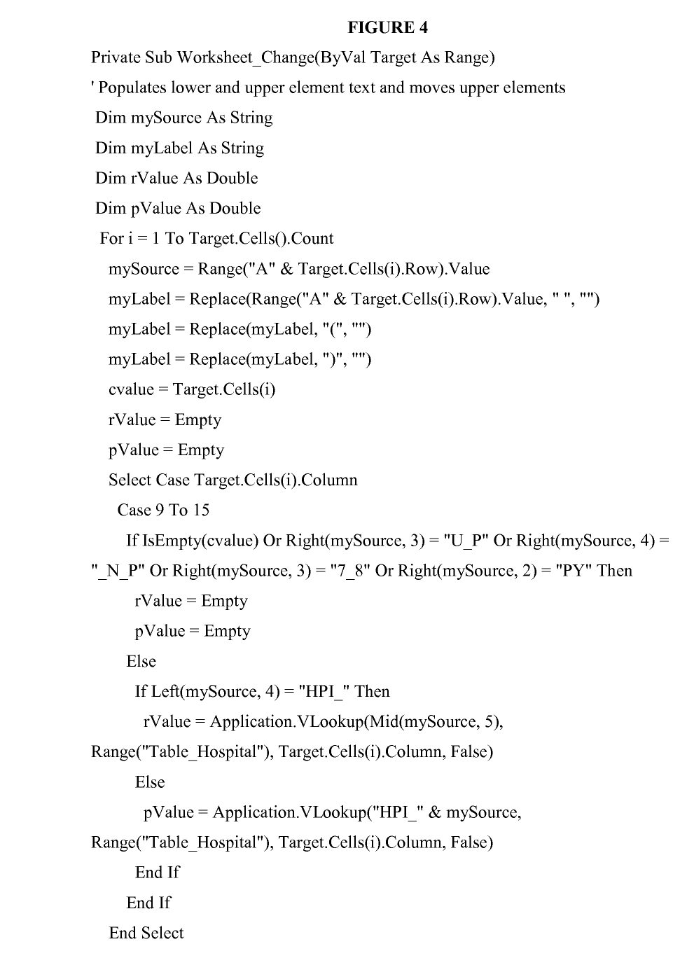

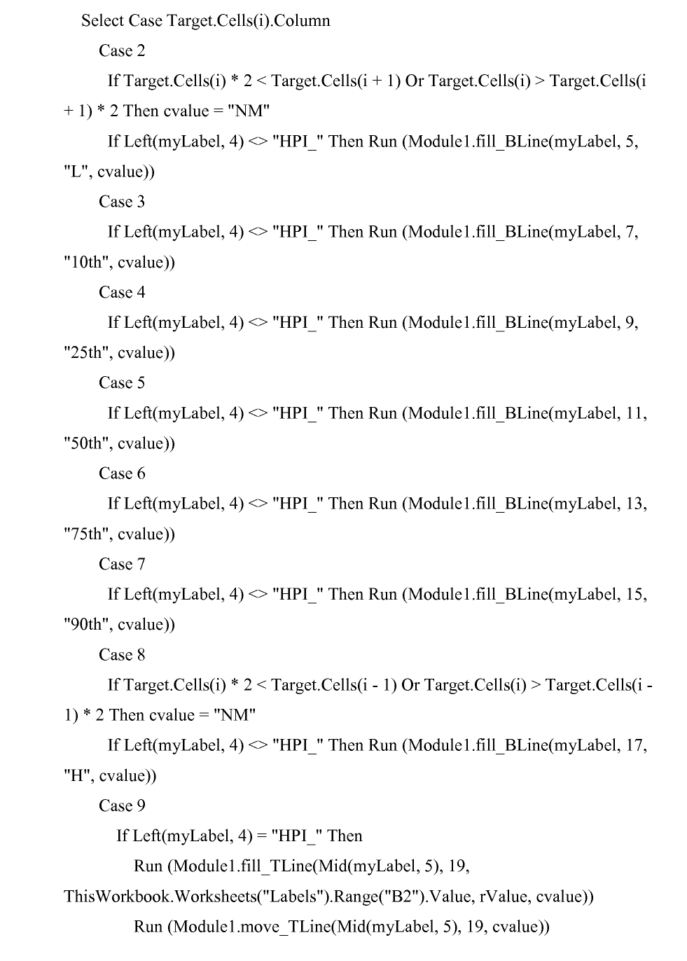

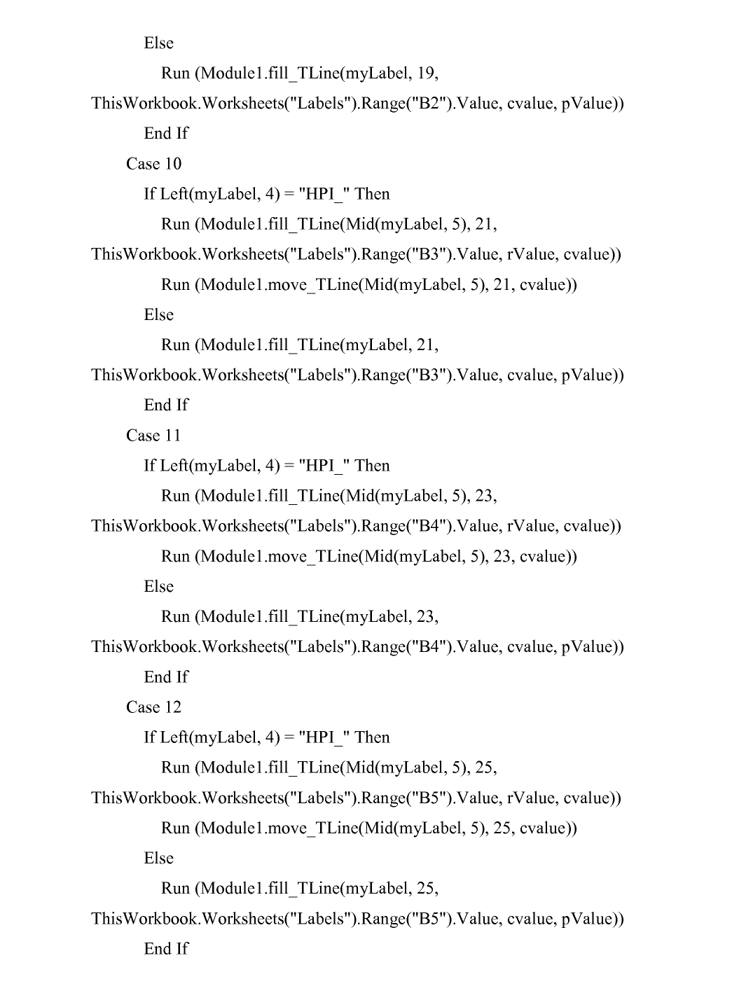

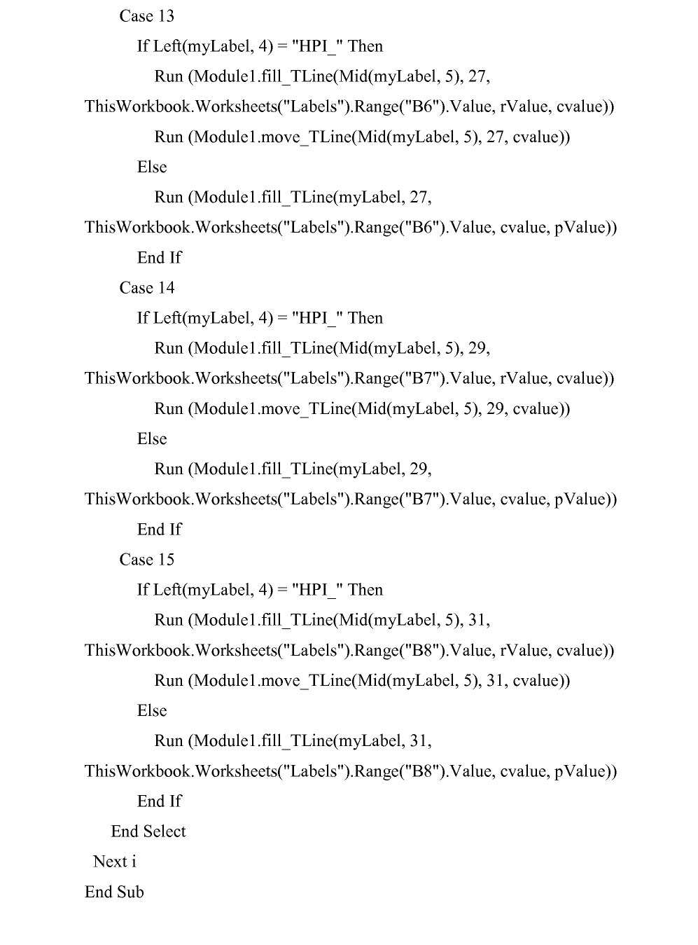

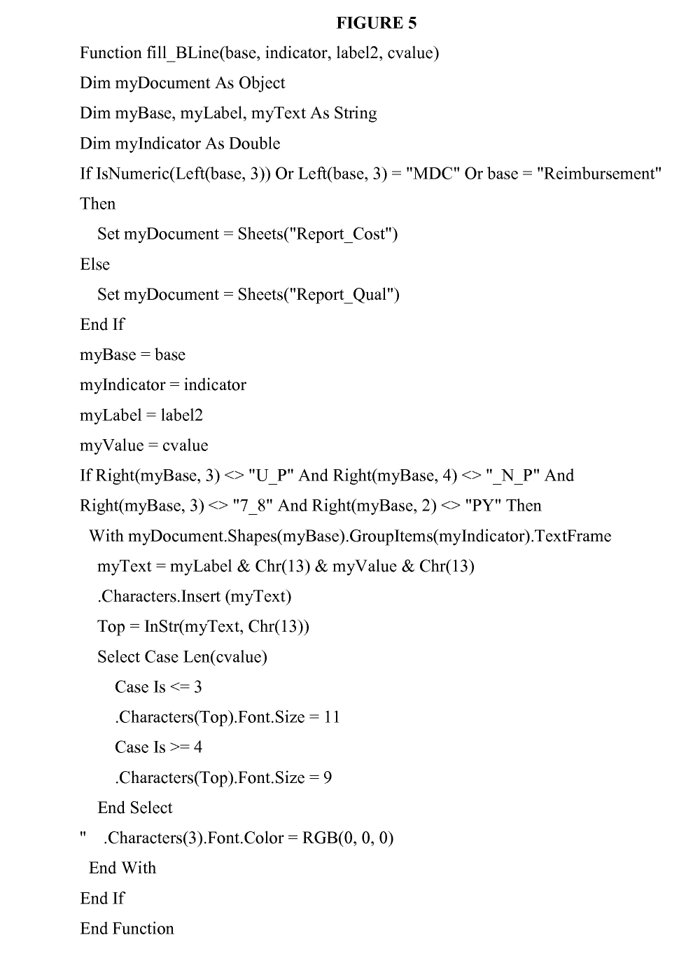

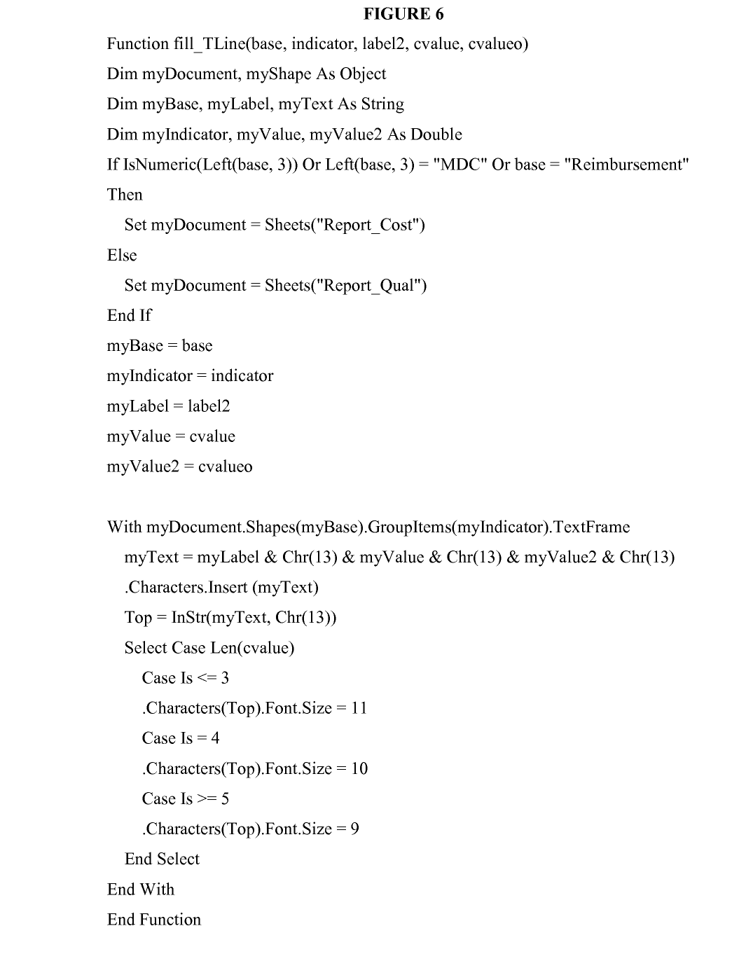

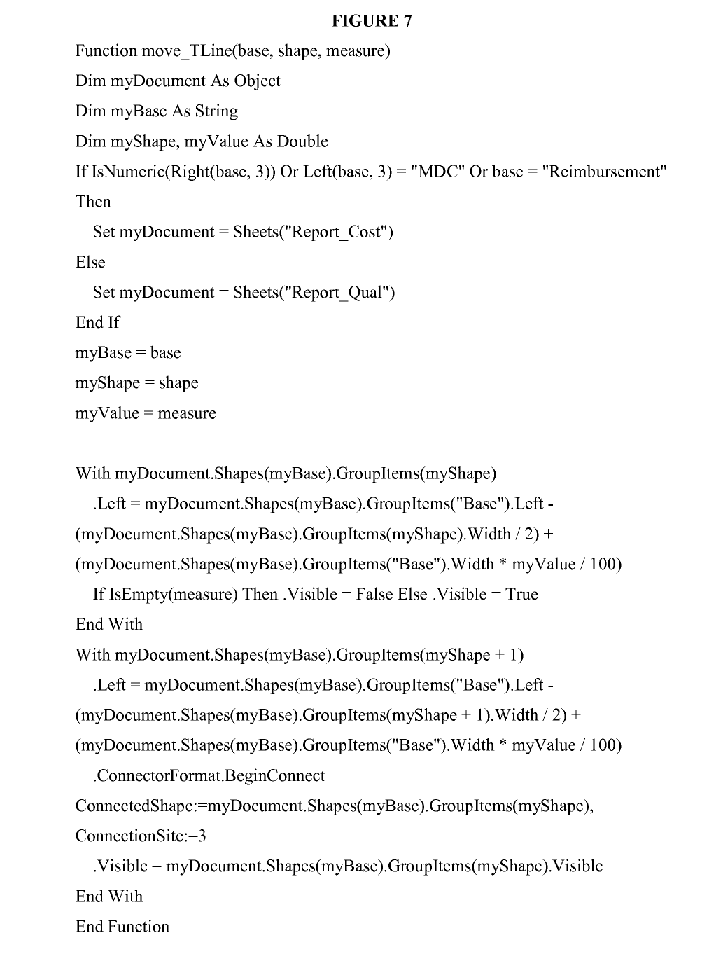

FIGS. 4-7 are visual basic programming instructions for populating and manipulating the graphical representations depicted in FIGS. 1-3. FIG. 5 (population of “below the line” labels and data), FIG. 6 (population of “above the line” labels and data) and FIG. 7 (movement of “within the line” line and its associated “above the line” labels and data) are sub-routines called by the event-triggered instructions of FIG. 4.

While the described embodiment depicts visual basis as the programming language, and the Microsoft Excel object model as the object model, other programming languages, object models and graphical output environments will be evident to one skilled in the art and might be used without departing from the spirit of the invention. As will further be realized, the programming code itself is capable of other and different embodiments and its several details are capable of modification in various obvious respects, all without departing from the scope of the present invention. Accordingly, the programming logic is to be regarded as illustrative in nature and not as restrictive.

What is claimed is:

1. A computer-based method for visually representing data, the method comprising:
distributing at least one set of data across at least two groupings;
visually representing the at least two groupings as a metric against which individual data elements are compared; and,
visually representing at least one individual data point in relation to the at least two groupings.

2. The method according to claim 1, wherein at least one data label is associated with the visually-represented groupings.

3. The method according to claim 1, wherein at least one visually-represented attention criteria is associated with the visually-represented groupings.

4. The method according to claim 1, wherein at least one data label is associated with the at least one visually-represented individual data element.

5. The method according to claim 1, wherein data labels associated with the visually-represented individual data elements are visually-distinct from each other.

6. A computer-based system for visually representing data, the system comprising:
means for distributing at least one set of data across at least two groupings;
means for visually representing the at least two groupings as a metric against which individual data elements are compared; and,
means for visually representing at least one individual data point in relation to the at least two groupings.

7. The system according to claim 6, wherein at least one data label is associated with the visually-represented groupings.

8. The system according to claim 6, wherein at least one visually-represented attention criteria is associated with the visually-represented groupings.

9. The system according to claim 6, wherein at least one data label is associated with the at least one visually-represented individual data element.

10. The system according to claim 6, wherein data labels associated with the visually-represented individual data elements are visually-distinct from each other.
